(19) United States
(12) Patent Application Publication
(10) Pub. No.: US 2014/0345651 A1
(43) Pub. Date: Nov. 27, 2014

(54) WATER DELUGE SYSTEM CLEANING APPARATUS AND METHOD

(71) Applicant: Hugh MacKenzie, Aberdeenshire (GB)

(72) Inventor: Hugh MacKenzie, Aberdeenshire (GB)

(73) Assignee: PARADIGM FLOW SERVICES LIMITED, Aberdeenshire (UK)

(21) Appl. No.: 14/126,939

(22) PCT Filed: Jun. 18, 2012
(86) PCT No.: PCT/GB2012/051400

§ 371 Date: Jul. 29, 2014

(30) Foreign Application Priority Data
Jun. 17, 2011 (GB) 1110297.7

(51) Int. Cl. B08B 9/04; A62C 35/68

(52) U.S. Cl. CPC B08B 9/04; A62C 35/68
USPC 134/22.11; 15/104.05

(57) ABSTRACT

A water deluge system cleaning apparatus and method of cleaning a water deluge system which does not require the water deluge system to be offline while it is being cleaned. This is achieved by a packing device that provides an annular seal within the water deluge system, and a cleaning device for cleaning the water deluge system that extends through the packing device. Arrangements of inlets and/or outlets comprising safety valves also provide for additional functionality such as debris extraction or fluid flushing while still allowing the water deluge system to remain online.

The present invention relates to water deluge systems, and in particular a water deluge system cleaning apparatus and associated method of cleaning a water deluge system. Embodiments of the invention provide apparatus and methods for the efficient cleaning of water deluge systems with the additional benefit that a water deluge system does not necessarily need to be taken offline.

### BACKGROUND TO THE INVENTION

Conventional fire sprinkler systems are used widely in factories and commercial properties, and increasingly in homes, as an active fire protection measure. A water supply is connected to a network of sprinklers, generally situated overhead, which are held closed until activated. Activation is usually by way of a heat sensitive element within one or more sprinklers reacting to ambient temperature exceeding an activation temperature, whereupon the sprinklers are opened and the water flows therethrough to extinguish the fire.

Water deluge systems are specifically designed to extinguish fires by dispensing a large volume of water over an entire hazard area. Accordingly, while water deluge systems are similar to conventional fire sprinkler systems, in a water deluge system all of the sprinklers or nozzles are open. As a consequence, water is not present in the piping system until activated. The piping system is filled with air at atmospheric pressure which is lower than the water pressure of the water supply to the deluge system; however water is prevented from entering the deluge system, until required, by a deluge valve. An example of a water deluge system is presented schematically in FIG. 1 (description to follow).

Water deluge systems are usually activated automatically by a fire alarm system (of course manual activation means are usually also available) which controls the deluge valve; when the deluge valve is opened water enters the piping system and is subsequently dispensed over the hazard area via the open sprinklers or nozzles. The deluge valve stays open until reclosed.

Of course, water deluge systems must be properly maintained and nozzles, and the associated pipework, must be kept clear to ensure the system will work effectively.

Recent tragic events in offshore installations have resulted from major failings in mechanical and safety systems, and in many cases there have been fires on board the assets. A poorly maintained deluge system may be unable to deposit a sufficient volume of water to extinguish a fire and as a result lead to rapid fire escalation which puts lives at risk and can cause catastrophic damage to assets.

Unfortunately it is believed that many offshore water deluge systems, particularly those on platforms and installations built pre-1990s, still fail to comply with the minimum safety requirements, largely due to internal corrosion, corrosion deposits and marine growth which can restrict water flow in the pipework and block nozzles.

Despite the long felt need for solutions to this problem there are few options available for the cleaning of water deluge systems. Chemical treatment methods, for example flushing and acid cleaning techniques, and high pressure retro-jetting techniques are conventionally used, but are understood to cause damage to pipework and require taking the deluge system offline which for reasons of safety may also require cessation of operations. Given the cost of operating an asset, for example several hundred thousand US$ per day for a drilling platform that may have a dozen or more deluge systems, cessation of operation can lead to significant loss of revenue. Chemical treatments also pose a health risk to personnel and the environment.

It is therefore an object of at least one embodiment of an aspect of the present invention to provide an apparatus for effective and efficient cleaning of water deluge systems, and a corresponding method.

It is also an object of at least one embodiment of an aspect of the present invention to provide an apparatus for cleaning water deluge systems without having to take the water deluge system offline, and a corresponding method.

### SUMMARY OF THE INVENTION

According to a first aspect of the invention, there is provided a water deluge system cleaning apparatus comprising a packing device to provide an annular seal within the water deluge system, and a cleaning device extending through the packing device and operable to effect cleaning of the water deluge system.

The invention thereby allows a cleaning device to be used to clean the water deluge system while the water deluge system remains online without compromising its ability to operate, by providing at least a partial annular seal within the water deluge system through which the cleaning device extends. The cleaning device may be operated externally.

Optionally, the packing device is configured for insertion in a water deluge system via a nozzle of the water deluge system. Alternatively, the packing device is configured for insertion directly into the pipework of the water deluge system. Further alternatively, the packing device is configured for insertion via a water deluge system attachment. Optionally, the packing device is inflatable. Alternatively, the packing device is an interference fit or push fit with pipework of the water deluge system.

Such embodiments of the invention may be inserted into the pipework through a nozzle or other outlet or interface, such as an endplate, or via an attachment such as a t-piece, to simply and quickly begin cleaning operations.

Optionally, the cleaning tool comprises a brush head mounted on a flexible shaft. Alternatively, or additionally, the cleaning tool comprises a jetting hose. Further alternatively, or additionally, the cleaning tool comprises a rotary power brush.

Optionally, the apparatus further comprises a pipe portion within which the packing device is disposed, the pipe portion configured for attachment to pipework of the water deluge system.

Such an embodiment provides for a device to be connected to a deluge system, for example via corresponding flanges on the device and deluge system, when it may not be possible to insert the packing device through a nozzle thereof. The pipe portion may be a t-piece.

Optionally, the apparatus further comprises an inlet upstream of the packing device to permit flushing of the deluge system. Advantageously, the apparatus is configured to permit flushing while the cleaning device cleans the deluge system. Most preferably, the inlet is provided with a valve biased in a closed position.

Optionally, the apparatus further comprises an outlet upstream of the packing device to allow debris to be removed from the water deluge system. Most preferably, the outlet is provided with a valve biased in a closed position. Optionally, the valve is configured to be controlled by a control system of the relevant deluge system. Optionally, the apparatus further comprises a debris collector.

Optionally, the inlet is capable of performing the function of the outlet, and vice versa. Alternatively, the inlet and outlet are located at opposite ends of a portion of the water deluge system to be cleaned.

According to a second aspect of the invention, there is provided a method of cleaning a water deluge system, the method comprising deploying or attaching a water deluge system cleaning apparatus according to the first aspect within or to the water deluge system.

Preferably, the method comprises inserting the packing device into pipework of the water deluge system. Where the packing device is an inflatable packer, the method preferably further comprises inflating the packing device.

Alternatively, where the apparatus comprises a pipe portion within which the packing device is disposed, the method further comprises attaching the pipe portion to the water deluge system.

Optionally, the method comprises attaching an inlet to the water deluge system. Optionally, the method comprises attaching an outlet to the water deluge system.

Preferably, the method further comprises moving the cleaning tool within pipework of the water deluge system to clean the pipework.

Optionally, the method further comprises removing the packing device or pipe portion from the water deluge system and subsequently inserting the packing device or attaching the pipe portion at another location.

Preferably, the method further comprises flushing the deluge system to remove loosened debris and/or deposits. Optionally, the method further comprises collecting debris and/or deposits for analysis. Advantageously, the cleaning tool is moved and the deluge system is flushed simultaneously.

Optionally, the method comprises pre-treating the pipework to help loosen debris and/or deposits.

Optionally, the method comprises applying a corrosion and/or a scale inhibitor to the pipework.

Advantageously, in the event of an emergency, the method further comprises the step of activating the water deluge system. Most preferably, in the event of an emergency, the method further comprises the step of closing one or more (inlet or outlet) valves of the apparatus.

Embodiments of the second aspect of the invention may include one or more features of the first aspect of the invention or its embodiments, or vice versa.

According to a third aspect of the invention, there is provided a packer sized to be deployed and to create a seal within a deluge system pipework, the packer having a throughbore to allow one or more cleaning tools to pass therethrough.

Embodiments of the third aspect of the invention may include one or more features of the first or second aspects of the invention or its embodiments, or vice versa.

According to a fourth aspect of the invention, there is provided a kit of parts for assembling a water deluge system cleaning apparatus, the kit of parts comprising a packing device according to the third aspect and a cleaning tool.

Embodiments of the fourth aspect of the invention may include one or more features of any of the first to third aspects of the invention or its embodiments, or vice versa.

### BRIEF DESCRIPTION OF THE DRAWINGS

There will now be described, by way of example only, various embodiments of the invention with reference to the drawings, of which:

FIG. 1 presents a schematic view of a water deluge system as known in the art;

FIG. 2 presents a schematic view of a water deluge system cleaning apparatus in accordance with an embodiment of the present invention;

FIG. 3 presents a schematic view of a portion of a water deluge system and a water deluge system cleaning apparatus in accordance with an alternative embodiment of the present invention; and

FIG. 4 presents a schematic view of a portion of a water deluge system and a water deluge system cleaning apparatus in accordance with a further alternative embodiment of the present invention.

### DETAILED DESCRIPTION OF PREFERRED EMBODIMENTS

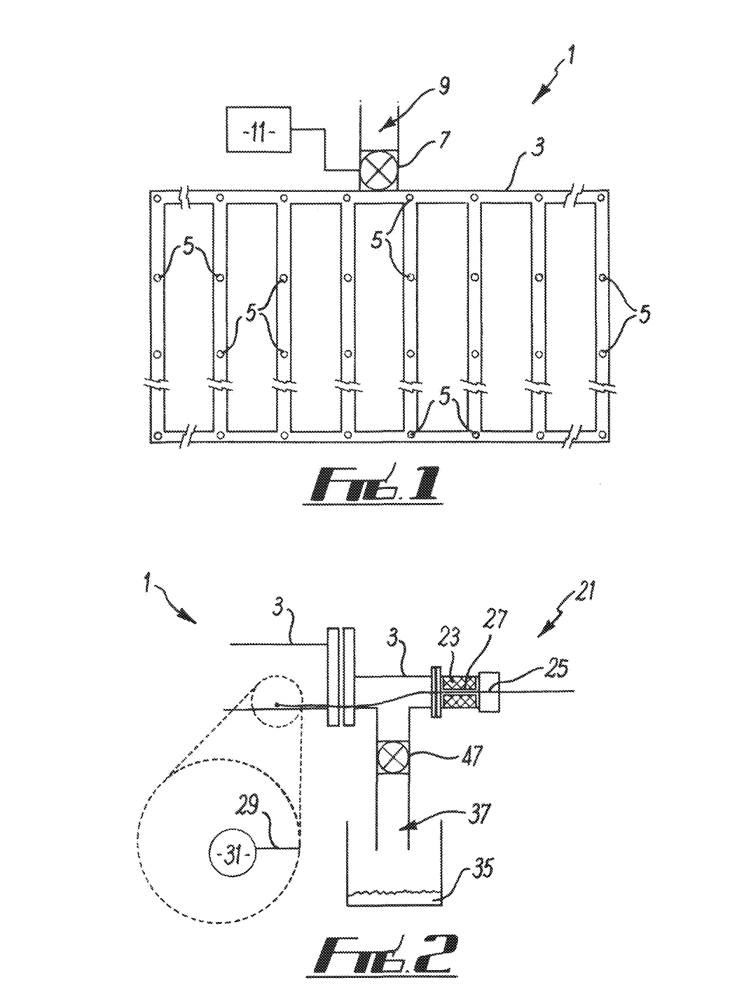

As mentioned above, FIG. 1 presents a schematic view, looking up at a water deluge system 1 in accordance with the prior art. The system 1 can be seen to comprise a network of pipes, i.e. pipework 3, throughout which are arranged a number of outlets or nozzles 5. Prior to activation, the pipework 3 is filled with air at atmospheric pressure. A deluge valve 7 separates the pipework 3 from a fire main 9 which retains a large volume of water. Upon activation, for example when a hazard is determined to be on fire by a control system 11, the deluge valve 7 is opened and water from the fire main 9 flows into the pipework 3 displacing the air and the water is simultaneously dispensed over the hazard (not shown but generally directly under the deluge system 1) through each of the outlets or nozzles 5.

FIG. 2 presents a schematic view of a water deluge system cleaning apparatus 21 in accordance with an embodiment of the present invention, comprising a packer 23 and a cleaning tool 25. The packer 23 provides an annular seal within the pipework 3, while the cleaning tool 25 is able to pass through a channel 27 extending through the packer 23. This permits external operation and control of the cleaning tool 25, while the packer 23 provides the seal that enables the deluge system cleaning apparatus to be used while the deluge system 1 remains online.

The packer 23 can be inflatable, deployed in a deflated state for ease of entry and inflated once in position. Alternatively, the packer 23 can be an interference fit or push fit with the pipework. In any case, it is important that at least a partial seal is formed to limit or prevent deluge water from escaping through the cleaning device should the system be activated.

The cleaning tool 25 illustrated in this exemplary embodiment comprises a flexible shaft 29 (see inset) and a brush head 31. Oscillation, reciprocation, rotation and vibration of the brush head 31 (by external manipulation of the entire tool 25 or the shaft 29 for example) effects a scrubbing or scouring action on the inner surfaces of the pipework 3 of the water deluge system 1. This enables debris, such as corrosion deposits and marine growth, to be removed from within the pipework.

By employing a flexible shaft 29, the cleaning tool 25 can be manoeuvred around bends and directed into hard-to-reach areas. Subsequently, the loosened debris can be flushed out of the system. This can be achieved by removing the cleaning apparatus 21 (or pulling the cleaning tool 25 back towards the packer 23) and flushing the system, or by way of an optional debris outlet 37 (as illustrated in FIG. 2). The debris outlet 37 consists of a length of pipe connected between the packer 23 and the pipework 3 as illustrated. The debris 35 can be collected for subsequent analysis and disposal.

As an alternative to the flexible shaft 29 and brush head 31, the cleaning tool 25 can be comprised of any suitable cleaning tool such as a jetting hose (to provide high pressure water jets), rotary power brush, or the like. Of course a combination of such cleaning tools may be employed, or indeed swapped for one another dependent on the particular application, type of corrosion or scale, or pipe material.

To assist in the loosening of debris, a small amount of an appropriate chemical (for example, citrus oil—which is an environmentally friendly solvent) may be applied. This can be applied as part of (i.e. during) the cleaning process or as a pre-cleaning process step.

Post-cleaning, the system 1 can be protected by applying a chemical treatment, such as a corrosion and/or scale inhibitor, to reduce or prevent further build-up. The cleaning process can be repeated as often as necessary.

A further optional feature of the cleaning apparatus is valve 47 which is illustrated as being within the debris outlet 37. The valve 47 serves a number of purposes. Key, however, is that the valve 47 provides a means for the cleaning apparatus to interface with a nozzle or other access to the pipework 3 while maintaining a seal such that cleaning fluids, debris, etc. are not able to exit the system in an uncontrolled fashion. Importantly, the valve 47 can be controlled by the same control system 11 that operates the deluge valve 7. By way of explanation, when cleaning a pipe 3 valve 47 will be in the open position to allow debris to be removed from the pipe. However on activation of valve 7 a valve 47 will automatically or manually close allowing pressure to build within the pipe and the remaining nozzles to perform to the expected standard.

In a typical cleaning operation using the cleaning apparatus 21, the pipework is first pre-treated using a mild solvent (such as citrus oil) to loosen at least some of the debris. This can be by way of a flush through the system or by jetting into or through one or more nozzles of the deluge system. Subsequently, the cleaning apparatus 21 is deployed by inserting the packing device into the pipework, through one of the nozzles and, in the case of an inflatable packing device, inflating the packing device to form an annular seal.

A cleaning tool is then inserted through a throughbore in the packing device (although the packing device may be deployed with the cleaning tool already extending therethrough in an alternative embodiment). The cleaning tool in this example is a brush head mounted on a flexible shaft, the brush head having multiple scrubbing attachments. The cleaning tool is then reciprocated, rotated and otherwise moved about within the pipework to effect a cleaning action. This loosens debris and deposits caused by corrosion and the like.

The cleaning action can continue for as long as required, determined to an extent by the length of the cleaning tool. Once the tool's useful length has been exploited, the packer can be removed and inserted back into the pipework at a different location, through another of the nozzles. This process is continued until the entire pipework has been cleaned.

At the end of the cleaning process (or at one or more intermediate stages) the deluge system can be flushed to removed debris from the pipework. This can be achieved by back flushing through nozzles to valve 47, or by jetting water through one or more nozzles and causing water and debris to exit through other nozzles. The debris can be collected for subsequent analysis.

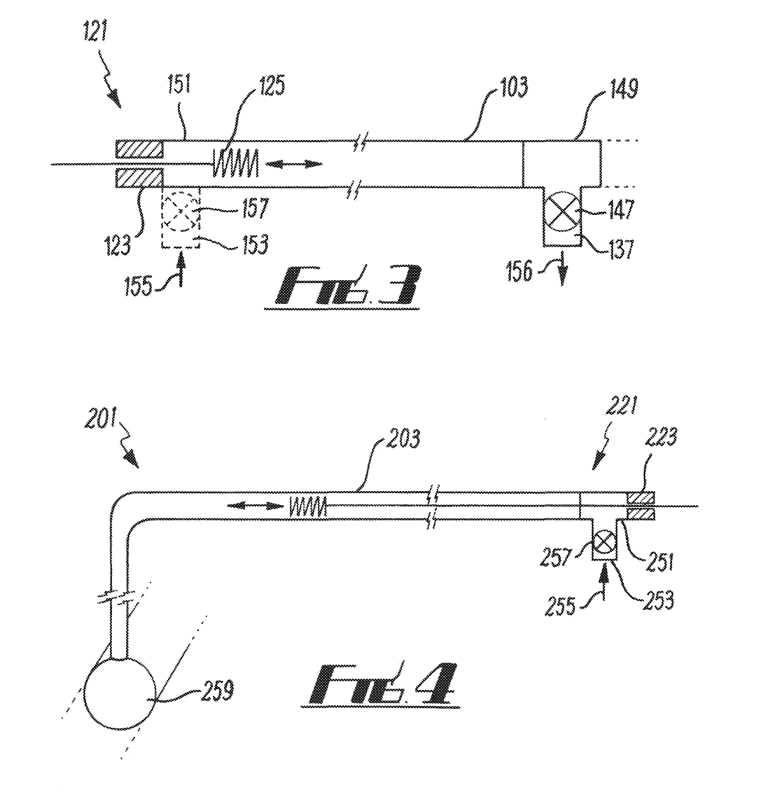

FIG. 3 illustrates a schematic view of an alternative water deluge system cleaning apparatus 121, comprising a packer 123 and a cleaning tool 125 as above. The packer 123 is inserted directly into an end of the pipework 103 and provides an annular seal, which the cleaning tool 125 extends through. Again, this permits external operation and control of the cleaning tool 125, while the packer 123 provides the seal that enables the deluge system to remain online during cleaning.

At the end of the portion of pipework 103 which is to be cleaned is located a t-piece 149. It is envisaged that the packer 123 and the t-piece 149 may be attached to the pipework at opposite ends of a deluge system branch—although the t-piece 149 is clearly suitable for installation at any point along the pipework 103. The t-piece is provided with a valve 147 within an outlet 137. As above, the valve 147 can be controlled by the same control system that operates the deluge valve. During cleaning operations, the valve 147 is held open to allow dislodged debris etc. to exit the pipework. On activation of the deluge system, valve 147 will automatically close allowing pressure to build within the pipework 103 and the deluge nozzles to perform to the expected standard.

Also illustrated in FIG. 3 is a further optional attachment in the form of a t-piece 151, indicated by dashed lines. This t-piece 151 provides an inlet 153 at the end of pipework 103 proximal to the packer 123. In fact, the packer could be inserted into the t-piece 151 after it is attached to the pipework 103. In any case, the portion of pipework between the two t-pieces 151 can be flushed using fluid inserted through the inlet 153 (see arrow 155) and exiting through outlet 137 (see arrow 156). While the flushing operation can be performed between cleaning operations, it is particularly advantageous to flush the pipework 103 during the cleaning operation (i.e. simultaneously) so that loosened debris is immediately entrained in the flushing fluid and carried away before it can be re-deposited.

Similarly to t-piece 149, t-piece 151 is provided with a valve 157 such that if the deluge system is activated during cleaning, the valve will close, thus preserving the operational capability of the water deluge system. In this way, cleaning and flushing can be achieved while the water deluge system remains online.

It is of course envisaged, and within the scope of the invention, that the inlet and outlet of FIG. 3 can be employed in the reverse sense, for example to permit flushing back and forth or simply to flush in the opposite direction. Furthermore, instead of employing separate fluid inlets and outlets for flushing, it will be possible to perform flushing via suitably configured or adapted deluge system nozzles.

FIG. 4 illustrates a schematic view of a further alternative water deluge system cleaning apparatus 221, again comprising a packer 223 and a cleaning tool 225. The packer 223 is again located at the end of the pipework 203 and provides an annular seal, which the cleaning tool 225 extends through. However, in this particular deluge system 201 the opposite end of the pipework 203 is connected directly to a larger deluge supply pipework 259.

Similarly to the system illustrated in FIG. 3, a t-piece 251 provides an inlet 253 at the end of pipework 203 proximal to the packer 223 which allows the portion of pipework between the t-piece 251 and the deluge main 209 to be flushed (during cleaning or before/after) using fluid inserted through the inlet 253 (see arrow 255). This will deposit loosened debris within the deluge supply pipework 259 which can subsequently be flushed (perhaps after several pipework sections have been cleaned.

Yet again, the presence of a valve 257 which closes if the deluge system is activated during cleaning allows the water deluge system to remain online during cleaning and during brushing.

It is thought that the majority of deluge systems on aged installations, e.g. older than 20 years, would fail to meet current safety requirements and performance standards. The significant cost associated with making such systems fit for purpose again, coupled with the required down-time, represents a major disincentive for operators to remedy the situation. The present invention however provides a quick, efficient way of cleaning such deluge systems without the necessary downtime and without damaging the pipework itself.

A follow on advantage will be that these aged deluge systems can be kept in working order, at reasonable cost with minimal disruption, far beyond their design lifetimes. This is particularly the case where assets lie in fields that are still commercially viable beyond levels previously anticipated. As safety is a primary concern that can ultimately govern whether an asset is maintained or shut down, the invention provides a means to extend an asset's lifetime. Embodiments of the invention even allow for a deluge water through-path, by-pass or shut-off (by way of a valve that can be controlled by the deluge control system) that ensures the deluge system can be activated without the presence of the cleaning system reducing effectiveness—meaning operations (e.g. drilling or production) can continue even during cleaning.

In an alternative embodiment of the invention, the packing device and cleaning tool are housed within a pipework section, the pipework section attachable to a deluge system and thus removing the necessity to insert the packing device into the deluge system itself. Once attached to the pipework of the deluge system the cleaning apparatus can be used as described above. The pipework section may also comprise a debris outlet (and/or fluid inlet) and associated valve corresponding to the debris outlet (and/or fluid inlet) and valve described above with respect to the first embodiment. Such an embodiment may be particularly useful where the nozzles are significantly narrower than the pipework, in which case a packing device which is able to pass through the nozzle and still form a seal within the pipework might only be realised by using an inflatable packer.

The invention provides a water deluge system cleaning apparatus and method of cleaning a water deluge system which does not require the water deluge system to be offline while it is being cleaned. This is achieved by a packing device that provides an annular seal within the water deluge system, and a cleaning device for cleaning the water deluge system that extends through the packing device. Arrangements of inlets and/or outlets comprising safety valves also provide for additional functionality such as debris extraction or fluid flushing while still allowing the water deluge system to remain online.

Various modifications may be made within the scope of the invention as herein intended, and embodiments of the invention may include combinations of features other than those expressly claimed.

1. A water deluge system cleaning apparatus comprising:
a pipe portion configured for attachment to pipework of the water deluge system;
a packing device to provide an annular seal within the pipe portion; and
a cleaning device extending through the packing device and operable to effect cleaning of the water deluge system;
wherein the packing device is configured to provide an annular seal with the water deluge system around the cleaning device;
wherein the apparatus further comprises an inlet or an outlet to the water deluge system, the inlet or the outlet comprising a valve operable to be closed on activation of a deluge valve.

2. A water deluge system cleaning apparatus according to claim 1, wherein the cleaning device is configured to be operated externally to the water deluge system.

3-5. (canceled)

6. A water deluge system cleaning apparatus according to claim 1, wherein the packing device is inflatable.

7. (canceled)

8. A water deluge system cleaning apparatus according to claim 1, wherein the cleaning tool comprises at least one of: a brush head mounted on a flexible shaft; a jetting hose; or a rotary power brush.

9-11. (canceled)

12. A water deluge system cleaning apparatus according to claim 1, wherein the pipe portion comprises a t-piece.

13. A water deluge system cleaning apparatus according to claim 1, further comprising an inlet upstream of the packing device to permit flushing of the deluge system.

14. (canceled)

15. A water deluge system cleaning apparatus according to claim 13, wherein the inlet comprises a valve biased in a closed position.

16. A water deluge system cleaning apparatus according to claim 1, wherein the apparatus further comprises an outlet upstream of the packing device to allow debris to be removed from the water deluge system.

17. A water deluge system cleaning apparatus according to claim 16, wherein the outlet is provided with a valve biased in a closed position.

18. A water deluge system cleaning apparatus according to claim 1, wherein the valve is configured to be controlled by a control system of the relevant deluge system.

19. A water deluge system cleaning apparatus according to claim 18, wherein the valve closes automatically when the deluge system is activated.

20. (canceled)

21. A method of cleaning a water deluge system, the method comprising attaching a water deluge system cleaning apparatus according to claim 1 to the water deluge system.

22. A method of cleaning a water deluge system according to claim 21, further comprising inflating the packing device.

23-26. (canceled)

27. A method of cleaning a water deluge system according to claim 21, comprising moving the cleaning tool within pipework of the water deluge system to clean the pipework.

28. A method of cleaning a water deluge system according to claim 21, comprising removing the pipe portion from the water deluge system and subsequently attaching the pipe portion at another location.

29. A method of cleaning a water deluge system according to claim 21, comprising flushing the deluge system to remove loosened debris and/or deposits.

30. A method of cleaning a water deluge system according to claim 29, wherein the cleaning tool is moved and the deluge system is flushed simultaneously.

31. A method of cleaning a water deluge system according to claim 21, comprising collecting debris and/or deposits for analysis.

32. A method of cleaning a water deluge system according to claim 21, comprising pre-treating the pipework to help loosen debris and/or deposits.

33. A method of cleaning a water deluge system according to claim 21, comprising applying a corrosion and/or a scale inhibitor to the pipework.

34. A method of cleaning a water deluge system according to claim 21, comprising activating the water deluge system in the event of an emergency.

35. A method of cleaning a water deluge system according to claim 21, further comprising closing one or more valves of the apparatus.

36. A kit of parts for assembling a water deluge system cleaning apparatus according to claim 1.

37. A water deluge system cleaning apparatus according to claim 1, wherein the apparatus comprises an inlet and an outlet to the water deluge system, the inlet and the outlet each comprising a valve operable to be closed on activation of a deluge valve.

38. A method of cleaning a water deluge system according to claim 29, wherein the apparatus comprises an inlet to the water deluge system, and the method comprises flushing the deluge system by introducing fluid through the inlet.

39. A method of cleaning a water deluge system according to claim 29, wherein the apparatus comprises an outlet to the water deluge system, and the method comprises flushing the deluge system by removing debris through the outlet
